(19) United States
(12) Patent Application Publication
(10) Pub. No.: US 2021/0317279 A1
(43) Pub. Date: Oct. 14, 2021

(54) FOAM COMPOSITIONS AND METHODS OF MAKING SAME

(71) Applicant: 3M INNOVATIVE PROPERTIES COMPANY, St. Paul, MN (US)

(72) Inventors: Jeffrey P. Kalish, St. Paul, MN (US); Caitlin E. Meree, St. Paul, MN (US); Joshua M. Fishman, Minneapolis, MN (US); Michael W. Voigt, Crystal, MN (US)

(21) Appl. No.: 17/267,557

(22) PCT Filed: Sep. 13, 2019
(86) PCT No.: PCT/IB2019/057732

§ 371 Date: Feb. 10, 2021

Related U.S. Application Data
(60) Provisional application No. 62/730,656, filed on Sep. 13, 2018.
(60) Provisional application No. 62/783,578, filed on Dec. 21, 2018.

(51) Int. Cl. C08J 9/00; C08K 3/34; C08J 9/10; B29C 44/06; B29C 44/04; B29C 44/56

(52) U.S. Cl. CPC C08J 9/0066; C08K 3/34; C08J 9/103; B29C 44/06; C08J 2203/04; B29C 44/56; C08J 2205/05; C08J 2201/03; C08J 2353/02; B29C 44/0492

(57) ABSTRACT

Open cell foam compositions are provided including a thermoplastic polymeric matrix and at least one filler. In some embodiments of the foam compositions, the filler includes nepheline syenite. Methods of making the foam compositions are described, the methods including (a) obtaining a composite materials containing a first thermoplastic polymer having a filler component and a blowing agent distributed therein; (b) coextruding the composite material with a second thermoplastic polymer and a third thermoplastic polymer to form a three-layer composition, wherein the three-layer composition includes a middle layer comprising an open cell foam formed from the foam composition, and the middle layer is disposed between the first and the second outer layers formed from the second and the third thermoplastic polymers, respectively; and (c) separating the middle layer from each of the first and the second outer layer. The first thermoplastic polymer is different from the second and the third thermoplastic polymers.

### FIELD

The present disclosure relates to open cell foam compositions including a thermoplastic polymeric material, and methods of forming the foam compositions.

### SUMMARY

In a first aspect, a foam composition is provided. The foam composition includes an open cell foam thermoplastic matrix material; and a filler component present in an amount of 20 weight percent (wt. %) or greater, based on the total weight of the thermoplastic matrix material. An average cell aspect ratio of the foam composition is 2.5 or less.

In a second aspect, another foam composition is provided. The foam composition includes an open cell foam thermoplastic matrix material and a filler component present in an amount of 20 wt. % or greater, based on the total weight of the thermoplastic matrix material. The filler component includes nepheline syenite.

In a third aspect, a method of making a foam composition is provided. The method includes (a) obtaining a composite material containing a first thermoplastic polymer having a filler component and a blowing agent distributed therein; (b) coextruding the composite material with a second thermoplastic polymer and a third thermoplastic polymer to form a three-layer composition; and (c) separating the middle layer from each of the first outer layer and the second outer layer, thereby forming the foam composition. The three-layer composition includes a middle layer disposed between a first outer layer and a second outer layer. The middle layer includes an open cell foam formed from the composite material, the first outer layer is formed from the second thermoplastic polymer, and the second outer layer is formed from the third thermoplastic polymer.

The first thermoplastic polymer is different from each of the second thermoplastic polymer and the third thermoplastic polymer.

In a fourth aspect, a foam composition is provided that is formed by the method according to the third aspect.

In a fifth aspect, a polymeric membrane is provided. The polymeric membrane includes a first thermoplastic elastomer layer including a foam composition according to the first aspect.

In a sixth aspect, an assembly is provided. The assembly includes a polymeric membrane according to the fifth aspect and a substrate.

Foam compositions according to at least certain aspects of the disclosure are open cell foams containing a large amount of inorganic filler, and may be prepared using extrusion. The above summary is not intended to describe each embodiment or every implementation of aspects of the invention. The details of various embodiments are set forth in the description below. Other features, objects, and advantages will be apparent from the description and from the claims.

### BRIEF DESCRIPTION OF THE DRAWINGS

FIG. 1 is a flow chart of an exemplary method of making a foam composition.

FIG. 2 is a light microscope (LM) image of the foam composition of Comparative Example 1.

FIG. 3 is an LM image of the foam composition of Comparative Example 2.

FIG. 4A is an LM image of the multilayer foam composition of Example 1.

FIG. 4B is an LM image of the foam composition of Example 1 after removal of the outer layers.

FIG. 5 is a scanning electron microscope (SEM) image of the multilayer foam composition of Example 1.

FIG. 6 is an SEM image of the foam composition of Example 5 after removal of the outer layers.

FIG. 7 is an SEM image of the multilayer foam composition of Example 8.

FIG. 8 is a schematic cross-sectional view of an exemplary polymeric membrane.

FIG. 9 is a schematic view of an exemplary assembly.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The terms “a”, “an”, “the”, “at least one”, and “one or more” are used interchangeably.

The term “and/or” means one or both such as in the expression A and/or B refers to A alone, B alone, or to both A and B.

The term “essentially” means 95% or more.

The term “average cell aspect ratio” means a numerical average from 25 or more cells, in which the aspect ratio for each cell in a cross section of foam is determined by dividing the major axis of an ellipse equivalent to the cell by the minor axis of an ellipse equivalent to the cell.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Open cell foam structures of the present disclosure have been produced via multilayer coextrusion combined with foam extrusion and delamination of (e.g., outer) skin layers. More particularly, it has been surprisingly discovered that open cell structures can be achieved by adding an inorganic filler to a thermoplastic polymeric matrix layer containing a blowing agent. Without wishing to be bound by theory, it is believed that when gas bubbles produced by the blowing agent expand to form a cellular structure, the interface between the filler particle and the polymer matrix becomes a weak point, which can rupture and create interconnected pathways between adjacent bubbles (e.g., cells) in the foam structure. This type of interconnected foam structure is called “open-cell” as compared to “closed-cell”, in which the foam cells or bubbles are isolated from each other. Most extruded foam compositions, in contrast, exhibit a closed-cell foam structure.

The present disclosure provides a process to produce open-cell foam structures using extrusion to create a multilayer structure with removable (e.g., peelable or strippable) skins. Certain applications of use require an open cell structure. For example, open cell structures are needed to achieve moisture wicking or breathability.

In a first aspect, a foam composition is provided. The foam composition includes an open cell foam thermoplastic matrix material and a filler component present in an amount of 20 weight percent (wt. %) or greater, based on the total weight of the thermoplastic matrix material. The largest average cell aspect ratio of the foam composition bisected in any plane is 2.5 or less. In certain embodiments, the average open cell aspect ratio is 2.4, 2.3, 2.2, 2.1, 2.0, 1.9, 1.8, 1.7, or 1.6 or less. The low average aspect ratio is typically achieved by the formation of foam cells during extrusion, which is in contrast to larger average aspect ratios achieved when a composition is stretched (e.g., oriented) when forming foam cells. An average open cell aspect ratio can be determined using image analysis, for instance the image analysis described in detail in the Examples below.

The thermoplastic matrix material comprises a thermoplastic polymer that is suitable for extrusion processing, e.g., a thermoplastic polymer having a glass transition temperature (T_{g}) in a range of from −100° C. to 350° C., or from 70° C. to 150° C. The term “glass transition temperature” refers herein to the “on-set” glass transition temperature by differential scanning calorimetry (DSC). Stated another way, the thermoplastic polymer can have a glass transition temperature of −100° C. or greater, −90° C., −80° C., −70° C., −60° C., −50° C., −40° C., −30° C., −20° C., −10° C., 0° C., 10° C., 20° C., 30° C., 40° C., 50° C., 60° C., or 70° C. or greater; and 350° C. or less, 300° C., 280° C., 260° C., 250° C., 240° C., 220° C., 200° C., 180° C., 160° C., 150° C., 120° C., or 100° C. or less. Some thermoplastic polymers may include multiple glass transition temperatures.

In some embodiments, the thermoplastic matrix material comprises an elastomeric material, for instance a thermoplastic polymer having a percent elongation at break of at least 110%, 115%, 120%, 125%, 130%, 135%, 140%, 145%, 150%, 155%, 160%, 165%, 170%, 175%, 180%, 185%, 190%, 195%, or at least 200%. The amount of force at 100% strain for a thermoplastic matrix material can be in a range of from about 20 pounds per square inch (psi) to about 300 psi, about 22 psi to about 250 psi, or less than, equal to, or greater than about 200 psi, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300 psi. Elastomeric materials may desirably provide one or more of flexibility, impact resistance, or conformability to the foam composition.

In many embodiments, the thermoplastic matrix material comprises a thermoplastic polymer comprising a polyacrylate, a polymethacrylate, a poly(methyl methacrylate), a polysiloxane, a styrene-isoprene block copolymer, a styrene ethylene butylene styrene polymer, a hydrogenated styrene ethylene butadiene styrene polymer, a polyamide-imide, a polyester, a polyphosphoesters, a polyethersulfone, a polyetherimide, a polyarylate, a polysulfone, a polyvinylchloride, an acrylonitrile butadiene styrene, a polystyrene, a poly(alpha-methyl styrene), a polyethylene, a polypropylene, a polyolefin, a polyurethane, a fluoroelastomer, a fluoropolymer, a polyamide, a polyacetal, a polyanhydride, a polycarbonate, a polyether, a poly(ether ketone), a poly(phenylene oxide), a poly(vinyl ester), a poly(vinyl ether), a poly(vinyl ketone), a poly(vinyl thioether), and copolymers thereof, or mixtures thereof. In select embodiments, the thermoplastic matrix material comprises a thermoplastic polymer comprising a hydrogenated styrene ethylene butadiene styrene polymer, a styrene-isoprene block copolymer, a styrene ethylene propylene styrene polymer, or mixtures thereof.

As used herein, polyacrylates refer to polymeric materials generally prepared by polymerizing acrylate monomers, and polymethacrylates refer to polymeric materials generally prepared by polymerizing methacrylate monomers. Acrylate and methacrylate monomers are referred to collectively herein as “(meth)acrylate” monomers. Polymers prepared from one or more of acrylate monomers, will be referred to collectively as “polyacrylates”, while polymers prepared from one or more of methacrylate monomers, will be referred to collectively as “polymethacrylates”. The polymers can be homopolymers or copolymers, optionally in combination with other, non-acrylate, e.g., vinyl-unsaturated, monomers. The copolymers of polyacrylates are acrylate copolymers, useful as uncrosslinked thermoplastic matrix material. Example suitable non-acrylate functional groups in acrylate copolymers include for instance, ethylene, acrylamides, acrylonitriles, methacrylonitriles, vinyl esters, vinyl ethers, vinyl pyrrolidinone, vinyl caprolactam, vinyl aromatic, dioxepines, styrenes, vinyl imidazoles, and vinyl pyridines. Hence, the acrylate or methacrylate is polymerized after being combined with the monomer having functional groups that copolymerize with the acrylate or methacrylate component. Specific examples of polyacrylate and polymethacrylate polymers include those prepared from free-radically polymerizable (meth)acrylate monomers or oligomers, such as described in U.S. Pat. No. 5,252,694 (Willett et al.) at col. 5, lines 35-68.

As used herein, “block copolymers” refer to elastomeric components in which chemically different blocks or sequences are covalently bonded to each other. Block copolymers include at least two different polymeric blocks that are referred to as the A block and the B block. The A block and the B block may have different chemical compositions and different glass transition temperatures or melting temperatures. Block copolymers of the present disclosure can be divided into four main classes: di-block ((A-B) structure), tri-block ((A-B-A) structure), multi-block (-(A-B)n-structure), and star block copolymers ((A-B)n-structure). Di-block, tri-block, and multi-block structures may also be classified as linear block copolymers. Star block copolymers fall into a general class of block copolymer structures having a branched structure. Star block copolymers are also referred to as radial or palmtree copolymers, as they have a central point from which branches extend. Block copolymers herein are to be distinguished from comb-type polymer structure and other branched copolymers. These other branched structures do not have a central point from which branches extend.

Suitable acrylic block copolymers comprise at least one acrylic monomer. Exemplary acrylic block copolymer may comprise monomer units including: alkyl ester methacrylates such as, e.g., methyl methacrylate, ethyl methacrylate, n-propyl methacrylate, isopropyl methacrylate, n-butyl methacrylate, isobutyl methacrylate, s-butyl methacrylate, t-butyl methacrylate, n-hexyl methacrylate, cyclohexyl methacrylate, 2-ethyl hexyl methacrylate, n-octyl methacrylate, lauryl methacrylate, tridecyl methacrylate, stearyl methacrylate, isobornyl methacrylate, benzyl methacrylate, or phenyl methacrylate; alkyl ester acrylate such as, e.g., n-hexyl acrylate, cyclo hexyl acrylate, 2-ethyl hexyl acrylate, n-octyl acrylate, lauryl acrylate, tridecyl acrylate, stearyl acrylate, n-butyl acrylate, isobutyl acrylate, sec-butyl acrylate, tert-butyl acrylate, or 2-octylacrylate; (meth)acrylate esters such as, e.g., those having the following ester groups: methoxy ethyl(meth)acrylate, ethoxy ethyl(meth)acrylate, diethyl amino ethyl meth)acrylate, 2-hydroxy ethyl(meth)acrylate, 2-amino ethyl(meth)acrylate, glycidyl (meth)acrylate, tetrahydro furfuryl(meth)acrylate; isobornyl(meth)acrylate, and combinations thereof. The acrylic block copolymer may comprise additional monomer units, for example, vinyl group monomers having carboxyl groups such as, e.g., (meth)acrylic acid, crotonic acid, maleic acid, maleic acid anhydride, fumaric acid, or (meth)acryl amide; aromatic vinyl group monomers such as, e.g., styrene, α-methyl styrene, or p-methyl styrene; conjugated diene group monomers such as, e.g., butadiene or isoprene; olefin group monomers such as, e.g., ethylene, or propylene; or lactone group monomers such as, e.g., E-caprolactone or valero lactone; and combinations thereof. One representative acrylic block copolymer is available from Kuraray (Tokyo, Japan), as the trade designation KURARITY LA2330.

Suitable styrenic block copolymers include for instance, styrene-isoprene-styrene copolymers, acrylonitrile-butadiene-styrene copolymers, styrene-butadiene-styrene copolymers, styrene-diene block copolymers, styrene-ethylene/butylene-styrene copolymers, and hydrogenated styrene ethylene butadiene styrene polymers. Example styrenic block copolymers may include linear, radial, star and tapered styrene-isoprene block copolymers such as KRATON D 1107P, available from Kraton Polymers (Houston, Tex.), and EUROPRENE SOL TE 9110, available from EniChem Elastomers Americas, Inc. (Houston, Tex.), linear styrene-(ethylene/butylene) block copolymers such as KRATON G1657 available from Kraton Polymers, linear styrene-(ethylene/propylene) block copolymers such as KRATON G1657X available from Kraton Polymers, styrene-isoprene-styrene block copolymers such as KRATON D1119P available from Kraton Polymers, acrylonitrile-butadiene-styrene copolymers such as LUSTRAN ABS 348 available from INEOS (London, UK), linear, radial, and star styrene-butadiene block copolymers such as KRATON DI 118X, available from Kraton Polymers, and EUROPRENE SOL TE 6205 available from EniChem Elastomers Americas, Inc., or styrene-ethylene-butylene-styrene copolymers, such as KRATON G1567 M, or styrene-ethylene-propylene copolymer, for example the polymer KRATON G1730 M, each commercially available from Kraton Polymers.

Moreover, polystyrenes that are not block copolymers may be used as the thermoplastic matrix material. Polystyrene is an aromatic hydrocarbon polymer synthesized from the monomer styrene. Polystyrenes of various molecular weights are commercially available, for instance from Sigma Aldrich Corporation (St. Louis, Mo.). Other suitable polystyrene resins, including general purpose polystyrene and high impact polystyrene (e.g., suitable for extrusion processing) available from Americas Styrenics LLC (Woodlands, Tex.) under the trade designation STYRON 610 for general purpose polystyrene, or STYRON 414 for high-impact polystyrene.

Suitable polyolefin polymers include for instance and without limitation, semicrystalline polymer resins such as polyolefins and polyolefin copolymers (e.g., based upon monomers having between 2 and 8 carbon atoms such as low density polyethylene, high density polyethylene, polypropylene, ethylene-propylene copolymers, etc.), polyesters and co-polyesters, and fluorinated homopolymers and copolymers. As used herein, the term “polyester” refers to polyesters made from a single dicarboxylate monomer and a single diol monomer and also to copolyesters which are made from more than one dicarboxylate monomer and/or more than one diol monomer. In general, polyesters are prepared by condensation of the carboxylate groups of the dicarboxylate monomer with hydroxyl groups of the diol monomer. As used herein, the terms “dicarboxylate” and “dicarboxylic acid” are used interchangeably and include lower alkyl esters having from 1 to 10 carbon atoms. As used herein, diol monomers include those monomers having two or more hydroxyl groups, for example, diols, triols, tetraols, and pentaols. Polyesters having molecular weights of from about 8,000 to about 50,000 may be useful.

Suitable polyamides include nylon-6, nylon-6,6, nylon-11, and nylon-12. Nylon-6 and nylon-6,6 offer better heat resistance properties than nylon-11 and nylon-12, whereas nylon-11 and nylon-12 offer better chemical resistance properties. In addition, other nylon materials such as nylon-6,12, nylon-6,9, nylon-4, nylon-4,2, nylon-4,6, nylon-7, and nylon-8 may be used, as well as ring-containing polyamides such as nylon-6,T and nylon-6,1. Suitable nylons include VESTAMID L2140, a nylon-12 available from Creanova, Inc. of Somerset, N.J. Additional suitable polyamides include, for example, poly(imino(1-oxohexamethylene)), poly(iminoadipoylimino hexamethylene), poly(iminoadipoyliminodecamethylene), polycaprolactam, and the like, or combinations thereof.

Suitable polyamide-imides may be prepared by reacting an aromatic diamine with trimellitic acid. Useful aromatic diamines include, for example, 4,4′-diaminobenzanilide, 4,3′-diaminobenzanilide, 3,4′-diaminobenzanilide, 3,3′-diaminobenzanilide, 3,5′-diaminobenzanilide, isophthal(4-aminoanilide), N,N′-m-phenylenebis(4-aminobenzamide), isophthal(3-aminoanilide), N,N′bis(3-aminobenzoyl), 2,4-diaminodiphenyl ether, 2,4-diaminophenyl ether, N,O-bis(3-aminobenzoyl)-p-aminophenol, and bis(4-amino-phenyl)isophthalic acid ester.

Suitable polysulfones include, for example, the reaction product of the sodium salt of 2,2-bis(4-hydroxyphenyl) propane and 4,4′-dichlorodiphenyl sulfone. Suitable polyethersulfones include, for example, poly(diphenylether sulfone), poly(diphenylsulfone-co-diphenylene oxide sulfone), and the like, or combinations thereof.

Polyetherimides are typically prepared by a two-step process from aromatic diamines and aromatic tetracarboxylic dianhydrides. The first step involves the addition of a dianhydride (e.g., pyromellitic dianhydride) to a diamine (e.g., 4,4′-oxydianiline), generally at ambient or low temperatures in a high boiling dipolar aprotic solvent. The second step includes a polycyclodehydration reaction of the poly(amic acid), which produces the final polyimide. Polyetherimides are manufactured by SABIC under the trade name ULTEM, and by Dupont under the trade name Kapton. Suitable polyetherimides include, for example, poly(pyromellitimide), and the like.

Polyarylates are aromatic polyesters with repeat units of ester groups and aromatic rings. Polyarylates are formed by polycondensation of a diacid chloride derivative of a dicarboxylic acid with a phenolic compound. Often, the dicarboxylic acid is terephthalic acid or isophthalic acid and the phenol is Bisphenol A or a derivative thereof. Suitable polyarylates include poly(p-hydroxybenzoate) and polybisphenol-A terephthalate.

Polyurethane is a generic term used to describe polymers prepared by the reaction of a polyfunctional isocyanate with a polyfunctional alcohol to form urethane linkages. The term “polyurethane” has also been used more generically to refer to the reaction products of poly isocyanates with any polyactive hydrogen compound including polyfunctional alcohols, amines, and mercaptans. Suitable polyurethanes are uncrosslinked thermoplastic polyurethanes sold under the trade names ESTANE, ISOPLAST, and PELLETHANE from the Lubrizol Corporation. Additional suitable polyurethans are uncrosslinked thermoplastic polyurethanes sold under the trade names IROGRAN, AVALON, KRYSTALGRAN, and IROSTIC from Huntsman.

Suitable fluoropolymers include a thermoplastic fluoropolymer obtained by polymerizing one or more types of fluorinated or partially fluorinated monomers. In this case, the specific microstructure of the fluoropolymer allows for a certain degree of crystallinity of the fluoropolymer, giving the thermoplastic properties. Generally, the thermoplastic fluoropolymer is at least a copolymer, but may be a terpolymer or a thermoplastic fluoropolymer that contains even four or more different copolymerizable monomers. Copolymerization allows for the decrease in crystallinity compared to the fluorine-based homopolymer, which can be advantageously used in the pressure-sensitive adhesive composition of this disclosure. Crosslinking of the thermoplastic fluoropolymer can be performed generally with a peroxide, a polyol or a polyamine, but is not limited thereto. The fluoropolymer may be a mixture of chemically different thermoplastic fluoropolymers, as well as, mixtures of chemically different fluoroelastomers and mixtures of thermoplastic fluoropolymers and fluoroelastomers. For instance, suitable thermoplastic fluoropolymers include copolymers of tetrafluoroethene (TFE) with perfluorinated, partially fluorinated or non-fluorinated comonomers, wherein the comonomer content is 1 wt. % of greater, 3 wt. % or greater, and may be up to 30 wt. % (as used hereinabove and below the weight percentages are based on total weight of the polymer unless specified otherwise). Examples include: fluorinated ethylene propylene (FEP) (e.g., copolymers of TFE, hexafluoropropylene (HFP), and other optional amounts of perfluorinated vinyl ethers); THV (e.g., copolymers of TFE, vinylidine fluoride (VDF) and HFP), perfluoro alkoxy (PFA) (e.g., copolymers of TFE and perfluoro alkyl vinyl ethers and/or perfluoro alkyl allyl ethers); homonomers and copolymers of VDF (e.g., PVDF); and homo- and copolymers of chlortrifluoroethylene (CTFE) and copolymers of TFE and ethylene (e.g., ETFE). Thermoplastic fluoropolymers (sometimes referred to as fluorothermoplasts or fluorothermoplastics) are described, for example, in “Fluoropolymer, Organic” in Ullmann's Encyclopedia of industrial chemisty, 7th edition, 2013, Wiley-VCH Verlag Chemie, Weinheim, Germany.

Suitable polysiloxanes (e.g., polyorganosiloxanes) are described, for instance, in co-owned U.S. Pat. No. 7,501,184 (Leir et al.) and U.S. Pat. No. 8,765,881 (Hays et al.), incorporated herein by reference in their entireties. Polyvinylchloride (PVC) is a polymer made up of a majority (e.g., at least 50%) vinyl chloride, and has been used as a matrix for foam products for years. A suitable PVC includes a PVC compound (e.g., suitable for extrusion processing) available under the trade designation GE FE1456CPF from Mexichem Specialty Compounds (Leominster, Mass.). Suitable polyacetals include polyoxymethylene (POM) including DELRIN from DuPont and DURACON from Polyplastics Co., Ltd. (Farmington Hills, Mich.). Suitable polyphosphoesters include poly(1,4-bis(hydroxyethyl)terephthalate-alt-ethyloxyphosphate) available from Sigma Aldrich (St. Louis, Mo.). Suitable polycarbonates include poly(bisphenol A carbonate) available from Sigma Aldrich (St. Louis, Mo.). Suitable poly(phenylene oxide)s include modified poly(phenylene oxide) and poly(phenylene ether) compounds under the trade name NORYL sold by Sabic Americas (Houston, Tex.).

Suitable poly(ether ketone)s are thermoplastic polymers containing ether and ketone functionality along the polymer backbone. Within each repeat unit, there can be one or more ether or ketone subunits in a row. For instance, poly(ether ether ketone)s, poly(ether ketone ketones)s, and poly(ether ether ketone ketone)s are all represented by the term poly(ether ketone). A suitable poly(ether ketone) is a poly(ether ether ketone) compound under the trade name VICTREX PEEK sold by Victrex PLC (Lancashire, UK).

The filler component can include one or more particulate fillers. Typically, the filler component comprises at least one inorganic filler, and may be a crystalline or amorphous material. In some embodiments, the filler component also can act as a nucleating agent which can decrease cost by obviating the need for additional nucleating agents in mixtures for forming a foam composition. Additionally, the filler component helps create voids that allow for decreased density in the foam composition. When the filler component comprises an inorganic filler, often the filler component comprises nepheline syenite, calcium carbonate, magnesium hydroxide, talc, alumina, zirconia, boehmite, amorphous silica, titania, kaolinite, calcite, calcium metasilicate, calcium sulphate, a clay, fly ash, calcium metasilicate (e.g., wollastonite), calcium sulphate (e.g., gypsum), zirconium silicate, zinc sulfide, zinc oxide, strontium titanate, pumice, barium sulfate, or mixtures thereof.

The filler component can have any suitable morphology. For example, the filler component can be spherical, elongated (e.g., fiber shaped), or have an irregular shape. In some embodiments, a (e.g., number average) largest dimension of the filler component (e.g., a largest diameter or a largest longitudinal dimension) is 200 nanometers or greater, 500 nanometers or greater, 750 nanometers or greater, 1 micrometer or greater, 3 micrometers or greater, 5 micrometers or greater, 7, 10, 12, 15, 17, 20, 22, 25, 28, 30, 32, 35, 38, or 40 micrometers or greater; and 300 micrometers or less, 280, 260, 240, 220, 200, 180, 160, 140, 120, 100, 80, 70, 60, or 50 micrometers or less. Stated another way, the largest dimension of the filler component may be in a range of from 200 nanometers to 300 micrometers or from 40 micrometers to 50 micrometers. Larger particles than about 300 micrometers might damage an extruder or clog a filter during processing of a foam composition.

In select embodiments, the filler component exhibits a hardness of 3.5 or more on the Mohs hardness scale, 4.0, 4.5, 5.0, 5.5, or even 6.0 or more; and 10 or less, on the Mohs hardness scale. It is known that on the Mohs hardness scale, which describes the resistance of a material to being scratched, that talc exhibits a hardness of 1, calcium carbonate exhibits a hardness of 3, and nepheline syenite exhibits a hardness of 6. A harder filler component tends to lead to a more abrasive foam composition.

In select embodiments, the filler component comprises nepheline syenite. For instance, in a second aspect, another foam composition is provided including nepheline syenite as a filler. The foam composition includes an open cell foam thermoplastic matrix material and a filler component present in an amount of 20 wt. % or greater, based on the total weight of the thermoplastic matrix material. Typically, 10 wt. % or greater, 12.5 wt. %, 15 wt. %, 17.5 wt. %, 20 wt. %, 22.5 wt. %, 25 wt. %, 30 wt. %, 35 wt. %, 40 wt. %, 45 wt. %, 50 wt. %, 55 wt. %, 60 wt. %, 65 wt. %, 70 wt. %, or 75 wt. % or greater, of the total filler component is nepheline syenite. One suitable commercially available nepheline syenite is 3M Industrial Grade Nepheline Syenite 700 Dry, from 3M (Little Rock, Ark.). This is a naturally occurring nepheline syenite mineral that has been processed to approximately 700 micrometers and finer (typically having a D₉₅ of 580 micrometers, a D₅₀ of 220 micrometers, and a D₁₀ of 33 micrometers, as determined using Microtrac S3500 Laser Diffraction).

The filler component is often present in an amount of up to 60 wt. %, based on the total weight of the thermoplastic matrix material, up to 57 wt. %, 55 wt. %, 52 wt. %, 50 wt. %, 47 wt. %, 45 wt. %, 42 wt. %, 40 wt. %, 37 wt. %, or up to 35 wt. %; and 20 wt. %, 22 wt. %, 25 wt. %, 27 wt. %, or 30 wt. % or greater, based on the total weight of the thermoplastic matrix material. Stated another way, the filler component may be present in an amount of 25 to 50 wt. %, 30 to 50 wt. %, or 20 to 45 wt. %, based on the total weight of the thermoplastic matrix material. The use of less than 20 wt. % typically does not result in the formation of open cells, and the use of greater than 60 wt. % tends to degrade the foam structure and mechanical integrity of the foam composition.

Foam compositions according to at least certain embodiments of the present disclosure may further contain at least one optional additive selected from the group consisting of an antiblock additive, a cell stabilizer, a surfactant, an antioxidant, an ultraviolet absorber, a lubricant, a processing aid, an antistatic agent, a colorant, an impact resistance aid, a matting agent, a flame retardant (e.g. zinc borate), a pigment, or a combination thereof.

A foam composition (e.g., in the form of a sheet) formed according to at least some embodiments of the present disclosure may have a thickness of 10 mils (254 micrometers) or greater, 15 mils, 25 mils, 50 mils, 75 mils, 100 mils, or even 125 mils or greater; and 250 mils (6.35 millimeters) or less, 225 mils, 200 mils, 175 mils, 150 mils, 130 mils, 110 mils, 90 mils, or even 70 mils (1.78 millimeters) or less. Stated another way, the foam composition may have a thickness of 10 mils (254 micrometers) to 250 mils (6.35 millimeters). The foam may be in the form of individual sheets, particularly for a thickness of greater than 20 mils. The (e.g., thinner) foam may be in the form of a roll-good.

A foam composition formed according to at least some embodiments of the present disclosure may have a density of 0.3 grams per cubic centimeter (g/cc) or greater, 0.31, 0.32, 0.33, 0.34, 0.35, 0.36, 0.37, 0.38, 0.39, 0.40, 0.41, 0.42, 0.43, 0.44, or 0.45 g/cc or greater; and 0.75 g/cc or less, 0.74, 0.73, 0.72, 0.71, 0.70, 0.69, 0.68, 0.67, 0.66, 0.65, 0.64, 0.63, 0.62, 0.61, 0.60, 0.59, 0.58, 0.57, 0.56, or 0.55 g/cc or less. Stated another way, the foam composition may have a density of 0.3 to 0.7 g/cc or 0.4 to 0.6 g/cc. It has been discovered that foam compositions according to at least certain aspects of the present disclosure have higher densities than other open cell foams, despite the relatively high filler content.

Advantageously, the open cell foam composition formed according to at least some embodiments of the present disclosure is fluid (e.g., gases, liquids, etc.) permeable. The extent of permeability may be measured as Gurley air flux, which is described in the Examples below. In some embodiments, the foam composition exhibits a Gurley air flux of 3,000 L/m²*hour*psi or greater, 4,000, 5,000, 6,000, 8,000, 10,000, 12,000, 15,000, 20,000, 25,000, 30,000, 35,000, 40,000, 50,000, 60,000, 70,000, 80,000, and even 100,000 L/m²*hour*psi or greater; and 200,000 L/m²*hour*psi or less, 190,000, 180,000, 170,000, 160,000, 150,000, 140,000, 130,000, 120,000, 110,000, or even 90,000 L/m²*hour*psi or less. The high Gurley air flux allows for use in applications such as filtration.

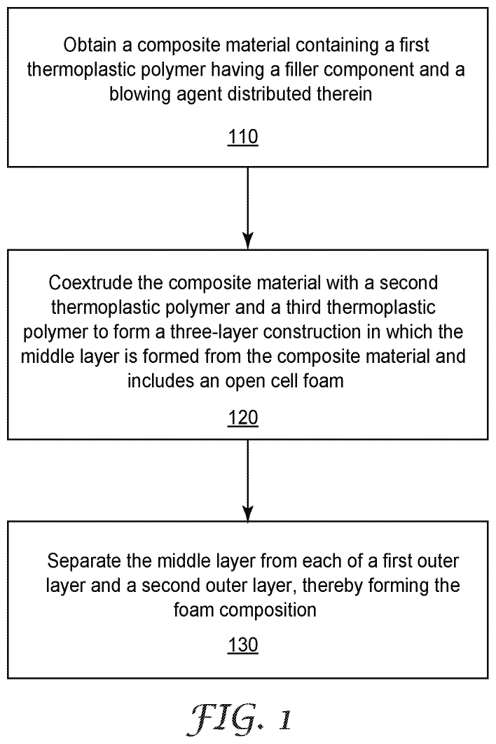

In a third aspect, a method of making a foam composition is provided. Referring to FIG. 1, the method includes (a) obtaining a composite material containing a first thermoplastic polymer having a filler component and a blowing agent distributed therein 110; (b) coextruding the composite material with a second thermoplastic polymer and a third thermoplastic polymer to form a three-layer composition 120; and (c) separating the middle layer from each of the first outer layer and the second outer layer, thereby forming the foam composition 130. The three-layer composition includes a middle layer disposed between a first outer layer and a second outer layer.

The middle layer includes an open cell foam formed from the composite material (120), the first outer layer is formed from the second thermoplastic polymer, and the second outer layer is formed from the third thermoplastic polymer. The first thermoplastic polymer is different from the second thermoplastic polymer and is also different from the third thermoplastic polymer. Stated another way, the method comprises:
a) obtaining a composite material comprising a first thermoplastic polymer having a filler component and a blowing agent distributed therein;
b) coextruding the composite material with a second thermoplastic polymer and a third thermoplastic polymer to form a three-layer composition comprising a middle layer disposed between a first outer layer and a second outer layer, wherein the middle layer comprises an open cell foam formed from the composite material, wherein the first outer layer is formed from the second thermoplastic polymer and the second outer layer is formed from the third thermoplastic polymer, and wherein the first thermoplastic polymer is different from each of the second thermoplastic polymer and the third thermoplastic polymer; and
c) separating the middle layer from each of the first outer layer and the second outer layer, thereby forming the foam composition.

The second thermoplastic polymer is immiscible with the first thermoplastic polymer. As used herein, “immiscible” refers to polymers with limited solubility and non-zero interfacial tension when blended, i.e., a blend whose free energy of mixing is greater than zero: ΔG≈ΔHₘ>0. Preferably, each of the second thermoplastic polymer and the third thermoplastic polymer are immiscible with the first thermoplastic polymer to allow for essentially complete separation of the middle layer (containing the first thermoplastic polymer) from the first and second outer layers (containing the second and third thermoplastic polymers). Two polymers are immiscible if they form an immiscible blend. An immiscible blend of polymers shows multiple amorphous phases as determined, for example, by the presence of multiple amorphous glass transition temperatures using differential scanning calorimetry or dynamic mechanical analysis. Miscibility of polymers is determined by both thermodynamic and kinetic considerations. Common miscibility predictors for non-polar polymers are differences in solubility parameters or Flory-Huggins interaction parameters. For polymers with non-specific interactions, such as polyolefins, the Flory-Huggins interaction parameter can be calculated by multiplying the square of the solubility parameter difference with the factor (V/RT), where V is the molar volume of the amorphous phase of the repeated unit, R is the gas constant, and T is the absolute temperature. As a result, the Flory-Huggins interaction parameter between two non-polar polymers is always a positive number.

In some embodiments, the second thermoplastic polymer and the third thermoplastic polymer are independently selected from polylactic acid (PLA), polyolefins, polyacrylates, styrene block copolymers, polyamides, and combinations thereof. Regarding combinations, for instance, blends of two polyolefins (e.g., polyethylene and polypropylene), may be suitable as the second and/or third thermoplastic polymer. If the first thermoplastic polymer is a styrene block copolymer, for example, each of the second and third thermoplastic polymers would not be a styrene block copolymer so that one or both of the second and third thermoplastic polymers can be readily removed from the foam composition. In some embodiments, the second thermoplastic polymer and the third thermoplastic polymer are the same polymer.

Suitable polylactic acid (“PLA”) polymers are described, for instance, in co-owned U.S. Application Publication No. 2017/0313912 (Zhou et al.), incorporated herein by reference. PLA can comprise an amorphous PLA polymer alone, a semicrystalline PLA polymer alone, or both in combination. Suitable examples of semicrystalline PLA include NATUREWORKS INGEO 4042D and 4032D. These polymers have been described in the literature as having a weight average molecular weight (Mw) of about 200,000 g/mole; number average molecular weight (Mn) of about 100,000 g/mole; and a polydispersity of about 2.0. Another suitable semicrystalline PLA is available as “SYNTERRA PDLA”. A suitable amorphous PLA includes NATUREWORKS INGEO 4060D grade. This polymer has been described in the literature to have a molecular weight Mw of about 180,000 g/mole.

Suitable polyolefins, polyacrylates, styrene block copolymers, and polyamides for use as a second thermoplastic polymer and/or a third thermoplastic polymer are as described in detail above with respect to the first aspect.

In some embodiments, the blowing agent comprises a chemical blowing agent, a physical blowing agent, or both a chemical blowing agent and a physical blowing agent. Volatile liquid and gas blowing agents tend to generate bubbles in the composite, leaving voids behind, to form the foam composition. Chemical compound blowing agents decompose and at least a portion of the decomposition product(s) generate bubbles in the composite, leaving voids behind. Preferably, the blowing agent is essentially free of hollow particles. This is because the shells of hollow particles do not rupture and thus lead to the formation of closed cell foam instead of open cell foam.

In some embodiments, the blowing agent comprises a chemical blowing agent selected from the group consisting of an azo compound, a diazo compound, a sulfonyl hydrazide, a sulfonyl semicarbazide, a tetrazole, a nitrosocompound, an acyl sulfonyl hydrazide, isatoic anhydride, hydrazones, hydrazines, thiatriazoles, azides, sulfonyl azides, oxalates, thiatrizene dioxides, a bicarbonate, a carbonate, citric acid, polycarbonic acid, a nitrate, a nitrite, a borohydride, or a combination thereof. Suitable chemical blowing agents include for instance and without limitation, a synthetic azo-based compound, a carbonate-based compound, a hydrazide-based compound, and combinations thereof. Useful specific compounds include, for example, 1,1-azodicarbonamide, azodiisobutyro-nitrile, benzenesulfonhydrazide, p,p′-oxybis(benzenesulfonylhydrazide, 5-phenyl tetrazole, p-toluenesulfonyl hydrazide, p-toluenesulfonyl semicarbazide, dinitrosopentamethylene tetramine, and hydrazo dicarbonamide. Encapsulated chemical blowing agents can also be used. Encapsulated chemical blowing agents can be prepared as described in co-owned International Application Number PCT/US2018/065613 (Fishman et al.), incorporated herein by reference.

When the blowing agent comprises a physical blowing agent, the blowing agent is typically selected from the group consisting of a volatile liquid, a gas, or a combination thereof. Specific materials that can be suitable physical blowing agents include carbon dioxide, nitrogen, argon, water, butane, 2,2-dimethylpropane, pentane, hexane, heptane, 1-pentene, 1-hexene, 1-heptene, benzene, toluene, a fluorinated hydrocarbon, methanol, ethanol, isopropanol, ethyl ether, isopropyl ketone, or mixtures thereof.

In some embodiments, inorganic fillers may be used as antiblock additives to prevent blocking or sticking of layers or rolls of the foam composition during storage and transport. Inorganic fillers include clays and minerals, either surface modified or not. Examples include talc, diatomaceous earth, silica, mica, kaolin, titanium dioxide, perlite, and wollastonite. Hence, certain materials may potentially act as more than one of a crystallization nucleating agent, a cell nucleating agent, an antiblock additive, a cell stabilizer, etc., in a foam composition.

In preparing a foam composition as described herein, the thermoplastic matrix material, filler component, and blowing agent (and any optional additives) are thoroughly mixed using any suitable means known by those of ordinary skill in the art. For example, the composite material may be mixed by use of a (e.g., Brabender) mixer, extruder, kneader or the like, preferably in an extruder.

In certain embodiments, the composite material may be prepared into the form of pellets, such as by extruding and pelletizing at least a portion of the mixture. One advantage to the mixture comprising a plurality of pellets is a greater ease of handling the mixture than certain alternate forms of mixtures.

Upon heating the composite material mixture, (e.g., subjection to a temperature ranging from 150° C.-270° C., inclusive) the blowing agent assists in generating voids to form the foam composition. In some embodiments, the blowing agent comprises a chemical blowing agent, a physical blowing agent, or a combination thereof (e.g., more than one blowing agent may be used in certain foam compositions). Useful categories of blowing agents include, for instance, a volatile liquid, a gas, and a chemical compound. Typically, the composite material mixture is heated in an extruder, plus each of the second thermoplastic polymer and the third thermoplastic polymer are each heated in an extruder. The extruder is set to heat each material, typically by subjection to a temperature of at least 130° C., at least 140° C., at least 150° C., at least 160° C., or at least 170° C.; and up to 230° C., up to 210° C., up to 200° C., up to 190° C., or up to 180° C.; such as ranging from 130° C. to 230° C. or 140° C. to 200° C., inclusive.

It was discovered that the use of first and second outer layers disposed on either side of a middle layer (i.e., containing filler component and blowing agent distributed in a thermoplastic polymer) in a multilayer coextrusion process (e.g., through a multilayer die) was unexpectedly able to form an open cell foam composition in the middle layer. The first outer layer and the second outer layer are believed to minimize the loss of activated blowing agent from out of the middle layer before it is able to form the foam cells.

In some embodiments, the first outer layer is extruded from an extruder set at a higher temperature than an extruder from which the middle layer is extruded. Similarly, in some embodiments, the second outer layer is extruded from an extruder set at a higher temperature than an extruder from which the middle layer is extruded. In such embodiment(s), the temperature of the extruder from which the middle layer is extruded is sufficiently low that the composite does not reach the activation temperature of the blowing agent. Rather, heat transfer from the first layer and/or the second layer to the middle layer activates of the blowing agent after the layers are in direct contact following extrusion, when the outer layers are located on either side of the middle layer.

To provide an open cell foam composition, the first outer layer and the second outer layer are each separated from the middle layer by peeling each of the first outer layer and the second outer layer apart from the middle layer. Alternatively, just one of the first and second outer layers may be delaminated from the middle layer to provide an open cell foam attached to a thermoplastic substrate.

In some embodiments, the second thermoplastic polymer, the third thermoplastic polymer, or both, has a percent elongation at break of 100% or less, 95%, 90%, 85%, or 80% or less, which may improve handling of the multilayer material versus having outer layers with a higher percent elongation at break. In embodiments in which the first thermoplastic polymer has a percent elongation at break or greater than 100%, the difference in percent elongation at break between the layers may assist in the delamination process of the first thermoplastic polymer from the second thermoplastic polymer, the third thermoplastic polymer, or both.

In a fourth aspect, a foam composition is provided that is formed by the method according to the third aspect. The components and characteristics of the foam composition are according to the first aspect, described in detail above.

The foam compositions can have various properties, as determined by the test methods set forth in the examples, including cell aspect ratio, foam composition density, and Gurley air flux.

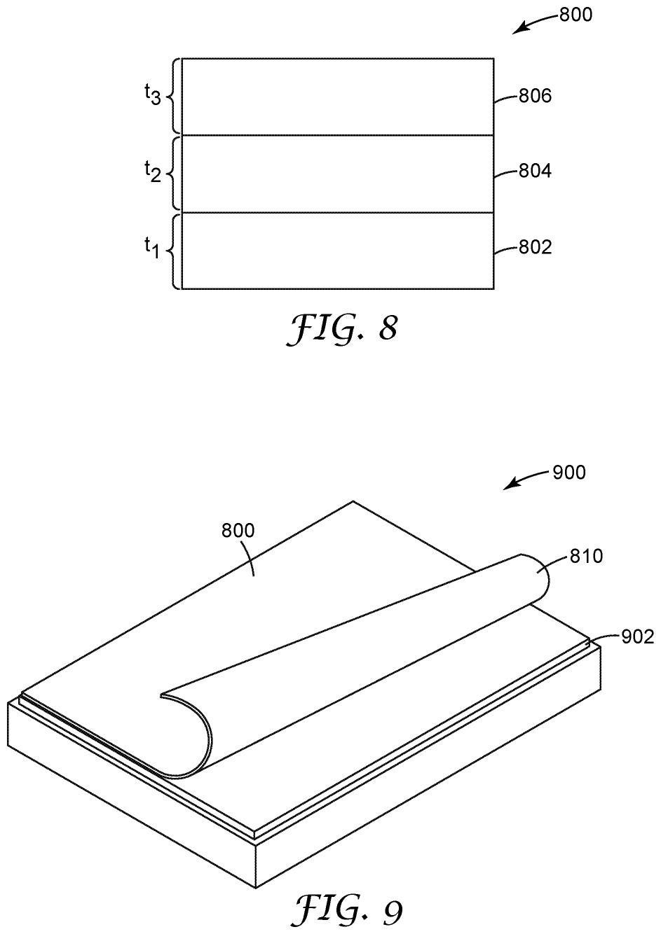

In a fifth aspect, a polymeric membrane is provided. The polymeric membrane comprises a first thermoplastic elastomer layer comprising a foam composition according to the first aspect, described in detail above. The polymeric membrane comprises one or more layers of thermoplastic elastomers. As shown in FIG. 8, a polymeric membrane 800 includes a first thermoplastic elastomer layer 802, a second thermoplastic elastomer layer 804, and a third thermoplastic elastomer layer 806. Although FIG. 8 shows the polymeric membrane 800 as including three thermoplastic elastomer layers, it is possible for the polymeric membrane 800 to have as few as one thermoplastic elastomer layer, or any plural number of thermoplastic elastomer layers. At least one of the layers 802, 804, or 806 comprises a first thermoplastic elastomer layer comprising a foam composition according to the first aspect as described in detail above. The first thermoplastic elastomer layer typically comprises a thermoplastic matrix material comprising an elastomeric material as described above.

The composition of any one of the layers 802, 804, and 806 can be the same. Alternatively, the composition of the layers 802, 804, and 806 can be different. As an example of a suitable composition, any of the layers 802, 804, or 806 can include a thermoplastic polymer. In further embodiments, any of the layers 802, 804, or 806 can include a thermoset polymer. The thermoplastic polymer can be in a range of from about 40 weight percent (wt. %) to about 100 wt. % of the layers 802, 804, and 806, from about 60 wt. % to about 95 wt. %, or less than, equal to, or greater than about 40 wt. %, 45, 50, 55, 60, 65, 70, 75, 80, 85, 90, 95, or about 100 wt. %.

Specific examples of suitable thermoplastic polymers for any of the layers 802, 804, and 806 include an acrylate, a methacrylate, a poly(methyl methacrylate), a siloxane, a styrene-isoprene block copolymer, a styrene ethylene butylene styrene polymer, a hydrogenated styrene ethylene butylene styrene polymer, a polyamide-imide, a polyethersulphone, a polyetherimide, a polyarylate, a polysulphone, a polypropylene, a plasticized polyvinylchloride, an acrylonitrile butadiene styrene, a polystyrene, a polyetherimide, a metallocene-catalyzed polyethylene, a polyethylene, a polyurethane, a fluoroelastomer, or copolymers thereof. In some embodiments, the siloxane can be a polydiorganosiloxane polyoxamide copolymer. Any of the layers 802, 804, and 806 can include one of these thermoplastic polymers or a mixture of the thermoplastic polymers. In some embodiments, any of the layers 802, 804, or 806 can be free of polypropylene. In embodiments in which any of the layers 802, 804, or 806 include the same thermoplastic polymer, it is possible to have a mixture of those polymers having different weight-average molecular weights.

As shown, each of the layers 802, 804, and 806 are substantially planar. A thickness t₁, t₂, or t₃, of any one of the layers 802, 804, and 806 can independently be in a range of from about 3 mils to about 200 mils, about 15 mils, to about 160 mils, or less than, equal to, or greater than about 3 mils, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or about 300 mils. In some embodiments of the polymeric membrane 800, a thickness (t₂) of the second layer 804 can be larger than a thickness (t₁ and t₃) of any one of the layers 802 and 806. In other embodiments, each of the first layer 802 and the third layer 806 can have a thickness that is greater than the second layer 804.

The polymeric membrane 800 can optionally include reinforcement components such as fibers, a scrim, a fabric, or a nonwoven. A reinforcement component can be located between any of the layers 802, 804, and 806 or it can be embedded within any layer or on external surfaces (e.g., a top or bottom surface). When present, a reinforcing component can help to add strength to the polymeric membrane 800 or to decrease flexibility in the polymeric membrane 800. Reinforcing components can include any suitable reinforcing material. For example, the reinforcing component can include a woven material, a non-woven material, or a mixture thereof. Examples of woven or non-woven materials can include fiber glass, nylon, cotton, cellulosic fiber, wool, rubber, polyester, polypropylene, or mixtures thereof. However, in some embodiments, the polymeric membrane 800 can be free of a reinforcement material and still be able to be sufficiently strong and resilient for any application.

In a sixth aspect, an assembly is provided. The assembly comprises a polymeric membrane according to the fifth aspect and a substrate. A first major surface of the polymeric membrane is adhered to the substrate. FIG. 9 is a schematic view of an assembly 900. A polymeric membrane 800, as described above, can be incorporated into any suitable assembly, such as a commercial roofing assembly. As shown in FIG. 9, a first major surface 810 of the polymeric membrane 800 is in contact with a substrate 902, e.g., adhered to the substrate 902. The substrate can be a roof, a water moisture barrier, a foam, a metal, asphalt, or a wood (e.g., natural wood, a wood composite, or a laminated wood).

As shown in FIG. 9, the polymeric membrane 100 is used as a commercial roofing membrane. The commercial roofing membrane can be substantially planar. This can be the result of the commercial roofing membrane being disposed on a planar roof. In some embodiments an external surface of the commercial roofing membrane is substantially free of any covering. However, in further embodiments the external surface of the commercial roofing membrane can be at least partially covered by a ballast layer (e.g., a rock layer). In further embodiments, the commercial roofing membrane can be covered with a scrim, soil, and grass or a different plant that can be grown in the soil. In further embodiments, the external surface can be at least partially covered with solar panels.

Various embodiments are provided that include foam compositions, methods of making same, and foam compositions made by the methods.

Embodiment 1 is a foam composition. The foam composition includes an open cell foam thermoplastic matrix material; and a filler component. The filler component is present in an amount of 20 weight percent (wt. %) or greater, based on the total weight of the thermoplastic matrix material. An average open cell aspect ratio of is 2.5 or less.

Embodiment 2 is the foam composition of embodiment 1, wherein the average open cell aspect ratio is 2.3 or less, 2.0 or less, or 1.8 or less.

Embodiment 3 is the foam composition of embodiment 1 or embodiment 2, wherein the filler component is an inorganic filler.

Embodiment 4 is the foam composition of any of embodiments 1 to 3, wherein the filler component includes nepheline syenite.

Embodiment 5 is a foam composition. The foam composition includes an open cell foam thermoplastic matrix material; and a filler component. The filler component is present in an amount of 20 wt. % or greater, based on the total weight of the thermoplastic matrix material, and the filler component includes nepheline syenite.

Embodiment 6 is the foam composition of embodiment 5, wherein 10 wt. % or greater, 25 wt. % or greater, or 50 wt. % or greater of the total filler component is nepheline syenite.

Embodiment 7 is the foam composition of any of embodiments 1 to 6, wherein the filler component comprises calcium carbonate, magnesium hydroxide, talc, alumina, zirconia, zinc oxide, boehmite, amorphous silica, titania, kaolinite, calcite, calcium metasilicate, calcium sulphate, a clay, fly ash, or mixtures thereof.

Embodiment 8 is the foam composition of any of embodiments 1 to 7, wherein a largest dimension of the filler component is in a range of from 200 nanometers to 300 micrometers or from 40 micrometers to 50 micrometers.

Embodiment 9 is the foam composition of any of embodiments 1 to 8, wherein the filler component is present in an amount of up to 60 wt. %, based on the total weight of the thermoplastic matrix material.

Embodiment 10 is the foam composition of any of embodiments 1 to 9, wherein the filler component is present in an amount of 25 to 50 wt. %, 30 to 50 wt. %, or 20 to 45 wt. %, based on the total weight of the thermoplastic matrix material.

Embodiment 11 is the foam composition of any of embodiments 1 to 10, wherein the thermoplastic matrix material includes a thermoplastic polymer having a glass transition temperature in a range of from −100° C. to 300° C., or from 70° C. to 150° C.

Embodiment 12 is the foam composition of any of embodiments 1 to 11, wherein the thermoplastic matrix material includes a thermoplastic polymer having a percent elongation at break of at least 110%, 130%, 150%, or 200%.

Embodiment 13 is the foam composition of any of embodiments 1 to 12, wherein the thermoplastic matrix material includes a thermoplastic polymer comprising an acrylate, a methacrylate, a poly(methyl methacrylate), a siloxane, a styrene-isoprene block copolymer, a styrene ethylene butadiene styrene polymer, a hydrogenated styrene ethylene butadiene styrene polymer, a polyamide-imide, a polyester, a polyphosphoester, a polyethersulfone, a polyetherimide, a polyarylate, a polysulfone, a polyvinylchloride, an acrylonitrile butadiene styrene, a polystyrene, a polyethylene, a polypropylene, a polyurethane, a fluoroelastomer, a fluoropolymer, a polyamide, a polyacetal, copolymers thereof, or mixtures thereof.

Embodiment 14 is the foam composition of any of embodiments 1 to 13, wherein the thermoplastic matrix material includes a thermoplastic polymer comprising a hydrogenated styrene ethylene butadiene styrene polymer, styrene-isoprene block copolymer, styrene ethylene propylene styrene polymer, or mixtures thereof.

Embodiment 15 is the foam composition of any of embodiments 1 to 13, further including at least one additive selected from the group consisting of an antiblock additive, a cell stabilizer, a surfactant, an antioxidant, an ultraviolet absorber, a lubricant, a processing aid, an antistatic agent, a colorant, an impact resistance aid, a matting agent, a flame retardant, a pigment, or a combination thereof.

Embodiment 16 is the composition of any of embodiments 1 to 14, wherein the filler component exhibits a hardness of 3.5 or more on the Mohs scale.

Embodiment 17 is the foam composition of any of embodiments 1 to 16, having a thickness of 10 mils (254 micrometers) to 250 mils (6.35 millimeters).

Embodiment 18 is the foam composition of any of embodiments 1 to 17, having a density of 0.3 to 0.7 grams per cubic centimeter (g/cc) or 0.4 to 0.6 g/cc.

Embodiment 19 is the foam composition of any of embodiments 1 to 18, having a Gurley air flux of 3000 L/m²*hour*psi or greater.

Embodiment 20 is a method of making a foam composition. The method includes (a) obtaining a composite material containing a first thermoplastic polymer having a filler component and a blowing agent distributed therein; (b) coextruding the composite material with a second thermoplastic polymer and a third thermoplastic polymer to form a three-layer composition; and (c) separating the middle layer from each of the first outer layer and the second outer layer, thereby forming the foam composition. The three-layer composition includes a middle layer disposed between a first outer layer and a second outer layer. The middle layer includes an open cell foam formed from the composite material, the first outer layer is formed from the second thermoplastic polymer, and the second outer layer is formed from the third thermoplastic polymer. The first thermoplastic polymer is different from each of the second thermoplastic polymer and the third thermoplastic polymer.

Embodiment 21 is the method of embodiment 20, wherein the blowing agent includes a chemical blowing agent.

Embodiment 22 is the method of embodiment 20 or embodiment 21, wherein the blowing agent includes a physical blowing agent.

Embodiment 23 is the method of any of embodiments 20 to 22, wherein the blowing agent is essentially free of hollow particles.

Embodiment 24 is the method of any of embodiments 20 to 23, wherein the blowing agent includes an encapsulated chemical blowing agent.

Embodiment 25 is the method of any of embodiments 20 to 24, wherein the blowing agent comprises a chemical blowing agent selected from the group consisting of a diazocompound, a sulfonyl hydrazide, a tetrazole, a nitrosocompound, an acyl sulfonyl hydrazide, isatoic anhydride, hydrazones, thiatriazoles, azides, sulfonyl azides, oxalates, thiatrizene dioxides, a bicarbonate, a carbonate, citric acid, polycarbonic acid, a nitrate, a nitrite, a borohydride, or a combination thereof.

Embodiment 26 is the method of any of embodiments 20 to 25, wherein the blowing agent includes a physical blowing agent selected from the group consisting of a volatile liquid, a gas, or a combination thereof.

Embodiment 27 is the method of any of embodiments 20 to 26, wherein the second thermoplastic polymer and the third thermoplastic polymer are the same polymer.

Embodiment 28 is the method of any of embodiments 20 to 27, wherein the first outer layer and the second outer layer are separated from the middle layer by peeling each of the first outer layer and the second outer layer apart from the middle layer.

Embodiment 29 is the method of any of embodiments 20 to 28, wherein the first outer layer is extruded from an extruder set at a higher temperature than an extruder from which the middle layer is extruded.

Embodiment 30 is the method of any of embodiments 20 to 29, wherein the second outer layer is extruded from an extruder set at a higher temperature than an extruder from which the middle layer is extruded.

Embodiment 31 is the method of any of embodiments 20 to 30, wherein the second thermoplastic polymer has a percent elongation at break of 100% or less.

Embodiment 32 is the method of any of embodiments 20 to 31, wherein the third thermoplastic polymer has a percent elongation at break of 100% or less.

Embodiment 33 is the method of any of embodiments 20 to 32, wherein the second thermoplastic polymer is immiscible with the first thermoplastic polymer.

Embodiment 34 is the method of embodiment 33, wherein the second thermoplastic polymer is selected from polylactic acid (PLA), polyolefins, polyacrylates, styrene block copolymers, and polyamides.

Embodiment 35 is the method of any of embodiments 20 to 33, wherein the foam composition is of any of embodiments 1 to 19.

Embodiment 36 is a foam composition formed by the method of any of embodiments 20 to 34.

Embodiment 37 is a polymeric membrane. The polymeric membrane includes a first thermoplastic elastomer layer including the foam composition of any of embodiments 1 to 19.

Embodiment 38 is the polymeric membrane of embodiment 37, wherein the polymeric membrane further includes a reinforcement component.

Embodiment 39 is the polymeric membrane of embodiment 38, wherein the reinforcement component includes at least one of fibers, a scrim, a fabric, or a nonwoven.

Embodiment 40 is an assembly. The assembly includes the polymeric membrane of any of embodiments 37 to 39 and a substrate.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise noted or readily apparent from the text, amounts of material are listed by weight, or by weight percent (“wt. %”).

Three-layer films were produced by using three extruders and a three-layer die. The equipment used is listed in Table 1 below.

TABLE 1

| Equipment | Description and Source |
|---|---|
| 25 mm twin screw | Twin screw extruder, type ZSK-25 manufactured |
| extruder (TSE) | by Krupp Werner & Pfleiderer, Ramsey, NJ, |
| | USA. |
| Two 1.25” (32 mm) | 1.25” (32 mm) single screw extruder |
| single screw | manufactured by Killion Extruders Inc., Cedar |
| extruders (SSE) | Grove NJ, USA |
| Three K-Tron feeders | Loss-in-weight solids feeders, model KCL-KT20, |
| | manufactured by K- Tron America, Pitman, NJ, |
| | USA |
| Casting station | 3-roll stack casting station, model KXE-512, |
| | manufactured by Davis Standard, Pawcatuck, CT, |
| | USA |
| Multi-layer extrusion | 3-layer film extrusion die, 6” (15 cm) wide, |
| die | manufactured by Premiere Dies Corp., Chippewa |
| | Falls, WI |
| Heated hoses | Heated hoses manufactured by Diebolt & Co., |
| | Springfield, MA, USA. |

All three K-tron feeders fed solids (powder and pellets) into the 25 mm twin screw extruder. To ensure good mixing of the filler into the polymer the twin screw extruder screw speed was set to 150 revolutions per minute (RPM). The single screw extruders were gravity fed polymer pellets. All extruders were connected to the 3-layer die via heated hoses. The twin screw extruder fed the core (center) layer of the 3-layer die. The 3-layers of polymer melt were joined inside the multi-layer die and the 3-layer molten film was cast onto a cooling roll in the casting station. The resulting 3-layer film was wound into a roll. Cooling of the casting roll was achieved by plumbing city water through a chrome finished steel roll. The chemical foaming agent, azodicarbonamide (Azo), which has an activation temperature of around 200° C., was activated in the die which was heated above 200° C.

Materials Used in the Examples

| Abbreviation | Description and Source |
|---|---|
| SEBS | Styrene-ethylene/budatiene-styene block copolymer, |
| | grade G1657 obtained from Kraton Polymers U.S. LLC, |
| | Houston, TX, USA. |
| PLA | Poly(lactic acid) polymer, trade name INGEO |
| | BIOPOLYMER, grade 4032D, obtained from |
| | NatureWorks LLC., Minnetonka, MN, USA. |
| NS | Mineral fines obtained under the trade name: 3M |
| | INDUSTRIAL GRADE NEPHELINE SYENITE 200 |
| | DRY, obtained from 3M Co., Little Rock, AK, USA. |
| Talc | Talc grade: MISTRON RCS obtained from Imerys Talc |
| | America, Inc., Three Forks, MT, USA. |
| CaCO₃ | Calcium carbonate, grade: SOCAL 31 obtained from |
| | Solvay Fluorides, LLC, Houston, TX, USA |
| Azo | Azodicarbonamide chemical foaming agent |
| | masterbatch, grade: PFM13691 Exothermic CFA, from |
| | Techmer PM, Clinton, TN, USA. |
| Azo-in-starch | Azodicarbonamide encapsulated in hydroxypropyl |
| eCBA | starch, prepared as described in Preparatory Example 3 |
| | of International Application Number |
| | PCT/U52018/065613 (Fishman et al.) Relative |
| | composition was 70% starch and 30% |
| | azodicarbonamide. |
| ZnO | Zinc Oxide Nanoparticles, Product #8415CY, from |
| | SkySpring Nanomaterias, Inc. Houston, TX. |
| EcoCell P | Endothermic chemical blowing agent, grade: EcoCell P, |
| | from Polyfil Corporation, Rockaway, NJ. |

### Test Methods

### Air Permeability

Air permeability was measured on a Densometer (obtained under the trade name GURLEY MODEL 41 iON DENSOMETER from Gurley Precision Instruments, Troy, N.Y.) equipped with an automatic timer. The volume was set to 50 cubic centimeters (cc), and the time to pass the 50 cc volume of air through the specimen was recorded. Air permeability, as reflected by air flux, was then calculated using the following formula:

$$Air flux = \frac{volume}{time \times pressure \times area}$$

where the volume was 50 cc, the pressure was 4.88 inches of water (0.176 pounds per square inch) (1.21 kPa), the area was 45.9 square centimeters (cm²), and the time was recorded.

### Cell Aspect Ratio

The cell structure of the foams was imaged by SEM using a JEOL JSM-60 10LA SEM (JEOL Ltd., Tokyo, JP). Samples were prepared by using a 410 scalpel to cut a thin strip of the foamed article along the machine direction (MD) of the film. The slices were mounted on a JEOL SEM stage such that the cross section of the strips was facing up and then sputter coated with Au/Pd for 30 seconds in a Denton Vacuum Desk V coating system (Denton Vacuum, LLC, Moorestown, N.J.). The images were analyzed using Image-Pro Premier 9.3 image analysis software (Media Cybernetics, Inc., Rockfille, Md.) to obtain the average cell aspect ratio using Image-Pro's algorithm. Image-Pro Premier defines the cell aspect ratio as the ratio of the major and minor axis of an ellipse equivalent to the cell. Cells were defined by hand using the polygon tool. The population of closed cells in the cross section was used to approximate the aspect ratio of the open cells before rupture. When possible, at least 25 cells were analyzed.

### Comparative Example 1

| Extruder | Layer | Composition | Extrusion Rate |
|---|---|---|---|
| 1.25” (32 mm) | Top | SEBS | 5 lbs/hr (2.27 kg/hr) |
| SSE | | | |
| 25 mm TSE | Core/middle | 98% SEBS, 2% Azo | 10 lbs/hr (4.54 kg/hr) |
| 1.25” (32 mm) | Bottom | SEBS | 5 lbs/hr (2.27 kg/hr) |
| SSE | | | |

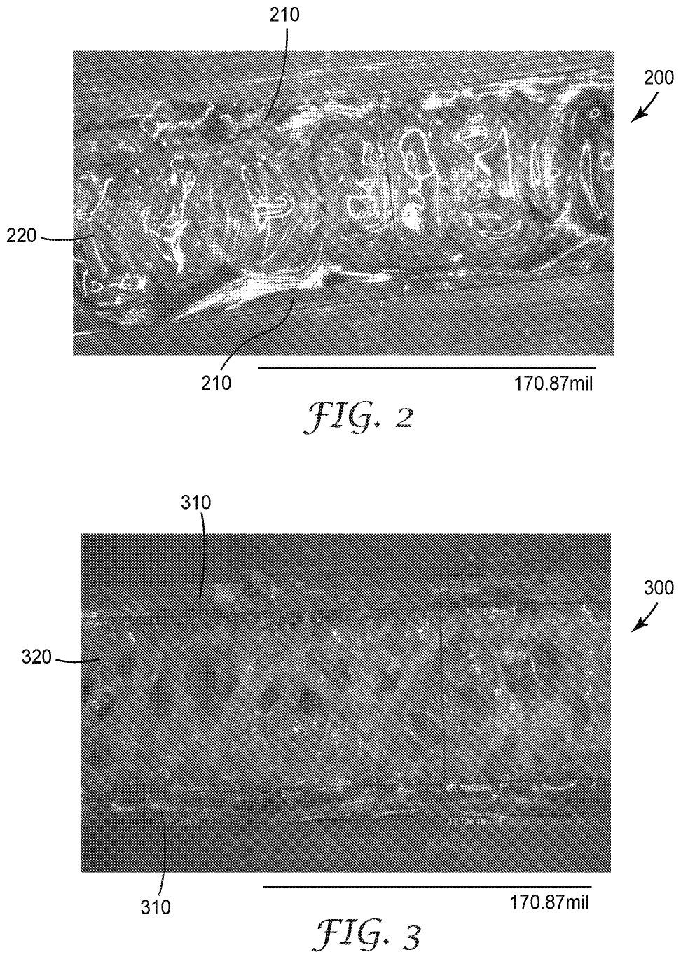

SEBS was extruded in a temperature range from 350° F. to 380° F. (176° C. to 193° C.). Comparative Example 1 (CE1), made according to the details of the Comparative Example 1 table above, produced a specimen with integral coextruded skin layers. Referring to FIG. 2, the outer layers 210 (top and bottom) of the construction 200 were not able to be separated from the core layer 220. CE1 produced a film that is not porous through the thickness of the film.

### Comparative Example 2

| Extruder | Layer | Composition | Extrusion Rate |
|---|---|---|---|
| 1.25” (32 mm) | Top | SEBS | 5 lbs/hr (2.27 kg/hr) |
| SSE | | | |
| 25 mm TSE | Core/ | 68% SEBS, | 10 lbs/hr (4.54 kg/hr) |
| | middle | 30% NS, 2% Azo | |
| 1.25” (32 mm) | Bottom | SEBS | 5 lbs/hr (2.27 kg/hr) |
| SSE | | | |

SEBS was extruded in a temperature range from 350° F. to 380° F. (176° C. to 193° C.). Comparative Example 2 (CE2), made according to the details of the Comparative Example 2 table above, produced a specimen with integral coextruded skin layers. Referring to FIG. 3, the outer layers 310 (top and bottom) of the construction 300 were not able to be separated from the core layer 320. CE2 produced a film that is not porous through the thickness of the film.

### Example 1

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 68% SEBS, | 10 lbs/hr (4.54 kg/hr) |
| | middle | 30% NS, 2% Azo | |
| 1.25” (32 mm) SSE | Bottom | PLA | 5 lbs/hr (2.27 kg/hr) |

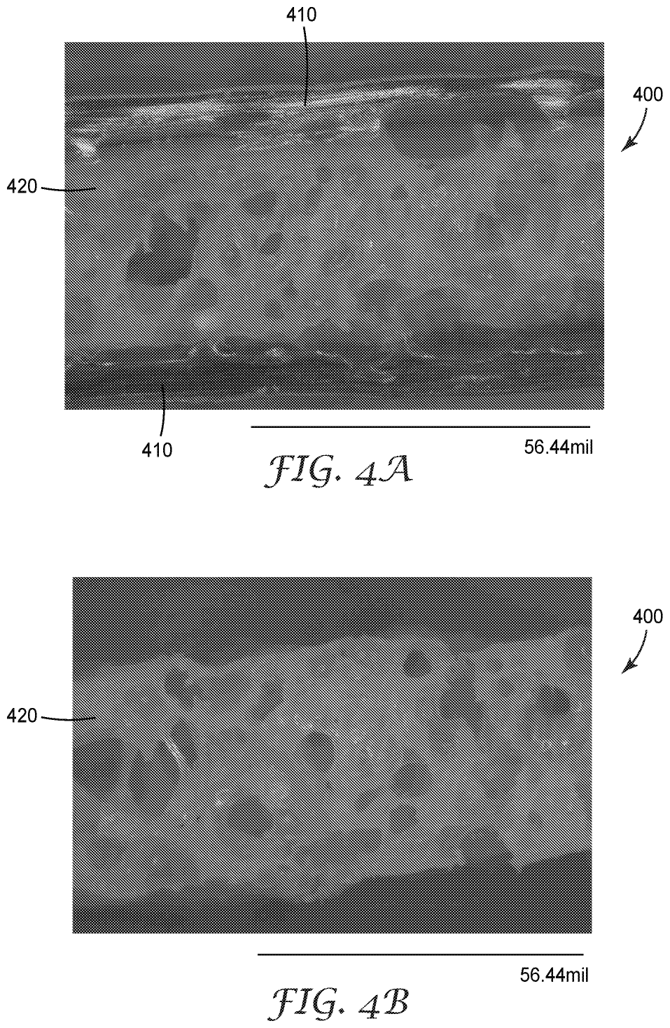

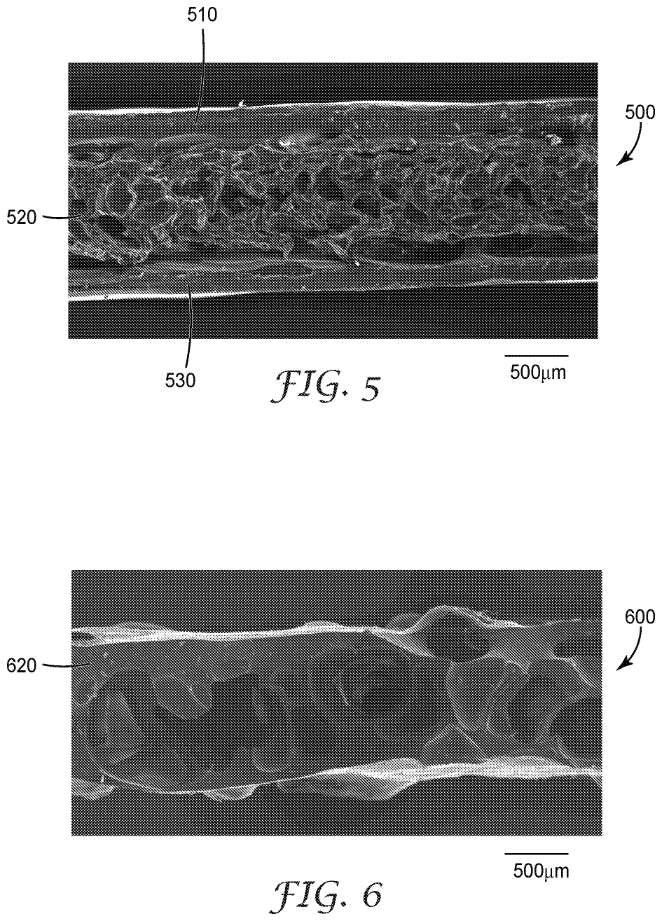

SEBS was extruded in a temperature range from 350° F. to 380° F. (176° C. to 193° C.), and PLA was processed in a temperature range from 380° F. to 410° F. (193° C. to 210° C.). Example 1, made according to the details of the Example 1 table above, produced a specimen where the PLA skin layers can easily delaminate from the SEBS foam core. Referring to FIG. 4A, the outer layers 410 (top and bottom) of the construction 400 were able to be separated from the core layer 420. FIG. 5 shows an SEM of the construction 500 of Example 1, including the outer layers 510, 530 and the core layer 520 disposed between the outer layers 510, 530. After peeling the PLA skins apart from the SEBS foam core, the air flux was measured with a GURLEY Model 4110N Densometer. Referring to FIG. 4B, the open-cell foam core layer 420 can be seen with the outer skin layers 410 removed.

### Comparative Example 3

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 93% SEBS, | 10 lbs/hr (4.54 kg/hr) |
| | middle | 5% NS, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Comparative Example 3 (CE3), made according to the details of the Comparative Example 3 table above, produced a specimen where the PLA skin layers can easily delaminate from the SEBS foam core. After peeling the PLA skins apart from the SEBS foam core, the air flux was measured with a GURLEY Model 4110N Densometer.

### Comparative Example 4

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 88% SEBS, | 10 lbs/hr (4.54 kg/hr) |
| | middle | 10% NS, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Comparative Example 4 (CE4), made according to the details of the Comparative Example 4 table above, produced a specimen where the PLA skin layers can easily delaminate from the SEBS foam core. After peeling the PLA skins apart from the SEBS foam core, the air flux was measured with a GURLEY Model 4110N Densometer.

### Example 2

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 58% SEBS, | 10 lbs/hr (4.54 kg/hr) |
| | middle | 40% NS, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193 C), and PLA was processed in a temperature range from 380° F. to 410° F. (193° C. to 210° C.). Example 2, made according to the details of the Example 2 table above, produced a specimen where the PLA skin layers can easily delaminate from the SEBS foam core. After peeling the PLA skins apart from the SEBS foam core, the air flux was measured with a GURLEY Model 4110N Densometer.

### Example 3

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 48% SEBS, 5 | 10 lbs/hr (4.54 kg/hr) |
| | middle | 0% NS, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Example 3, made according to the details of the Example 3 table above, produced a specimen where the PLA skin layers can easily delaminate from the SEBS foam core. After peeling the PLA skins apart from the SEBS foam core, the air flux was measured with a GURLEY Model 4110N Densometer.

### Example 4

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 68% SEBS, | 10 lbs/hr (4.54 kg/hr) |
| | middle | 30% talc, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Example 4, made according to the details of the Example 4 table above, produced a specimen where the PLA skin layers can easily delaminate from the SEBS foam core. After peeling the PLA skins apart from the SEBS foam core, the air flux was measured with a GURLEY Model 4110N Densometer.

### Example 5

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 68% SEBS, 30% | 10 lbs/hr (4.54 kg/hr) |
| | middle | CaCO3, 2% Azo | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Example 5, made according to the details of the Example 5 table above, produced a specimen where the PLA skin layers can easily delaminate from the SEBS foam core. After peeling the PLA skins apart from the SEBS foam core, the air flux was measured with a GURLEY Model 4110N Densometer. Referring to FIG. 6, the core layer 620 of the construction 600 is shown, after separation from the outer layers.

### Example 6

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 68% SEBS, | 10 lbs/hr (4.54 kg/hr) |
| | middle | 30% ZnO, 2% Azo | |
| 1.25” (32 mm) SSE | Bottom | PLA | 5 lbs/hr (2.27 kg/hr) |

SEB was extruded in a temperature range from 350° F. to 380° F. (176° C. to 193° C.), an PLA was processed in a temperature range from 380° F. to 410° F. (193° C. to 210° C.). Example 6, made according to the details of the Example 6 table above, produced a specimen where the PLA skin layers can easily delaminate from the SEBS foam core. After peeling the PLA skins apart from the SEBS foam core, the air flux was measured with a GURLEY Model 4110N Densometer.

### Example 7

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 64% SEBS, 30% NS, | 10 lbs/hr (4.54 kg/hr) |
| | middle | 6% Azo-in-starch | |
| | | eCBA | |
| 1.25” (32 mm) SSE | Bottom | PLA | 5 lbs/hr (2.27 kg/hr) |

SEBS was extruded in a temperature range from 350° F. to 380° F. (176° C. to 193° C.), and PLA was processed in a temperature range from 380° F. to 410° F. (193° C. to 210° C.). Example 7, made according to the details of the Example 7 table above, produced a specimen where the PLA skin layers can easily delaminate from the SEBS foam core. After peeling the PLA skins apart from the SEBS foam core, the air flux was measured with a GURLEY Model 4110N Densometer.

### Example 8

| Extruder | Layer | Composition | Extrusion Rate |
|---|---|---|---|
| 1.25” (32 mm) SSE | Top | PLA | 5 lbs/hr (2.27 kg/hr) |
| 25 mm TSE | Core/ | 62% SEBS, | 10 lbs/hr (4.54 kg/hr) |
| | middle | 30% NS, 8% | |
| | | Ecocell P | |
| 1.25” (32 mm) SSE | Bottom | PLA | 5 lbs/hr (2.27 kg/hr) |

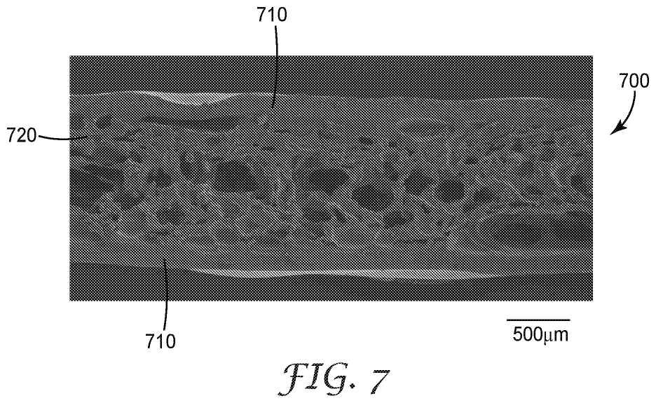

SEBS was extruded in a temperature range from 350° F. to 380° F. (176° C. to 193° C.), and PLA was processed in a temperature range from 380° F. to 410° F. (193° C. to 210° C.). Example 8, made according to the details of the Example 8 table above, produced a specimen where the PLA skin layers can easily delaminate from the SEBS foam core. Referring to FIG. 7, the outer layers 710 (top and bottom) of the construction 700 were able to be separated from the core layer 720. After peeling the PLA skins apart from the SEBS foam core, the air flux was measured with a GURLEY Model 4110N Densometer.

### Comparative Example 4

| Extruder | Layer | Composition | Extrusion Rate |
|---|---|---|---|
| 1.25” (32 mm) SSE | Top | | Off |
| 25 mm TSE | Core/ | 68% SEBS, | 10 lbs/hr (4.54 kg/hr) |
| | middle | 30% NS, 2% Azo | |
| 1.25” (32 mm) SSE | Bottom | | Off |

SEBS was extruded in a temperature range from 350° F. to 380° F. (176° C. to 193° C.). The top and bottom layer extruders were turned off to produce a single layer film according to the details of the Comparative Example 4 (CE4) table above. The air flux was measured with a GURLEY Model 4110N Densometer.

### Air Flux Results:

| Example | Air Flux | Specimen thickness |
|---|---|---|
| number: | (L/m² * hr * psi) | (mm) |
| CE1 | 0 | 3.10 |
| 1 | 5790 | 0.74 |
| CE2 | 0 | 1.13 |
| CE3 | 0 | 0.78 |
| 2 | 8190 | 0.45 |
| 3 | 36000 | 0.5 |
| 4 | 142000 | 0.45 |
| 5 | 81900 | 1.23 |
| 6 | 38500 | 0.49 |
| 7 | 63400 | 0.60 |
| 8 | 162000 | 0.85 |
| CE4 | 2550 | 1.13 |

### Cell Aspect Ratio Results

| Sample | Cell aspect ratio |
|---|---|
| 1 | 1.99 |
| 5 | 1.37 |
| 8 | 1.93 |

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments.

All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A foam composition comprising:
an open cell foam thermoplastic matrix material; and
a filler component present in an amount of 20 weight percent (wt. %) or greater, based on the total weight of the thermoplastic matrix material,
wherein an average cell aspect ratio of the foam is 2.5 or less.

2. The foam composition of claim 1, wherein the filler component is an inorganic filler.

3. The foam composition of claim 1, wherein the filler component comprises nepheline syenite.

4. A foam composition comprising: an open cell foam thermoplastic matrix material; and a filler component present in an amount of 20 wt. % or greater, based on the total weight of the thermoplastic matrix material, wherein the filler component comprises nepheline syenite.

5. The foam composition of claim 4, wherein 10 wt. % or greater, 25 wt. % or greater, or 50 wt. % or greater of the total filler component is nepheline syenite.

6. The foam composition of 5, wherein the filler component comprises or further comprises calcium carbonate, magnesium hydroxide, talc, alumina, zirconia, zinc oxide, boehmite, amorphous silica, titania, kaolinite, calcite, calcium metasilicate, calcium sulphate, a clay, fly ash, or mixtures thereof.

7. The foam composition of claim 1, wherein the filler component is present in an amount of up to 60 wt. %, based on the total weight of the thermoplastic matrix material.

8. The foam composition of claim 1, wherein the thermoplastic matrix material comprises a thermoplastic polymer having a percent elongation at break of at least 110%, 130%, 150%, or 200%.

9. The foam composition of claim 1, wherein the thermoplastic matrix material comprises a thermoplastic polymer comprising a hydrogenated styrene ethylene butadiene styrene polymer, styrene-isoprene block copolymer, styrene ethylene propylene styrene polymer, or mixtures thereof.

10. The foam composition of claim 1, having a density of 0.3 to 0.7 grams per cubic centimeter (g/cc) or 0.4 to 0.6 g/cc.

11. The foam composition of claim 1, having a Gurley air flux of 3000 L/m²*hour*psi or greater.

12. A method of making a foam composition, the method comprising:
a) obtaining a composite material comprising a first thermoplastic polymer having a filler component and a blowing agent distributed therein;
b) coextruding the composite material with a second thermoplastic polymer and a third thermoplastic polymer to form a three-layer composition comprising a middle layer disposed between a first outer layer and a second outer layer, wherein the middle layer comprises an open cell foam formed from the composite material, wherein the first outer layer is formed from the second thermoplastic polymer and the second outer layer is formed from the third thermoplastic polymer, and wherein the first thermoplastic polymer is different from each of the second thermoplastic polymer and the third thermoplastic polymer; and
c) separating the middle layer from each of the first outer layer and the second outer layer, thereby forming the foam composition.

13. The method of claim 12, wherein the blowing agent comprises a chemical blowing agent, a physical blowing agent, or both.

14. (canceled)

15. The method of claim 12, wherein the blowing agent comprises an encapsulated chemical blowing agent.

16. The method of claim 12, wherein the first outer layer and the second outer layer are separated from the middle layer by peeling each of the first outer layer and the second outer layer apart from the middle layer.

17. The method of claim 12, wherein the first outer layer is extruded from an extruder set at a higher temperature than an extruder from which the middle layer is extruded.

18. The method of claim 12, wherein the second thermoplastic polymer is immiscible with the first thermoplastic polymer.

19. A foam composition formed by the method of claim 12.

20. A polymeric membrane comprising:
a first thermoplastic elastomer layer comprising the foam composition of claim 1.

21. An assembly comprising:
the polymeric membrane of claim 20; and
a substrate;
wherein a first major surface of the polymeric membrane is adhered to the substrate.
